(19) United States
(12) Patent Application Publication
(10) Pub. No.: US 2011/0125300 A1
(43) Pub. Date: May 26, 2011

(54) Non-Intrusive Acoustic Monitoring for Equipment Diagnostic and Fault Reporting

(75) Inventors: Peeyush Jaiswal, Boca Raton, FL (US); Naveen Narayan, Kirkland, WA (US)

(73) Assignee: INTERNATIONAL BUSINESS MACHINES CORPORATION, Armonk, NY (US)

(21) Appl. No.: 13/017,968

(22) Filed: Jan. 31, 2011

Related U.S. Application Data
(63) Continuation-in-part of application No. 12/197,891, filed on Aug. 25, 2008, now abandoned.

(51) Int. Cl. G06F 17/00

(52) U.S. Cl. 700/94

(57) ABSTRACT

A method, computer program product, and a computer system are provided for acoustic monitoring and fault reporting. A computer identifies a sound from a consumer device. Responsive to identifying the sound from a consumer device, the computer converts the sound to an acoustic signal. Responsive to converting the sound to an acoustic signal, the computer generates a current acoustic fingerprint from the acoustic signal. Responsive to generating the acoustic fingerprint, the computer identifies whether the current acoustic fingerprint contains an ideal acoustic fingerprint. Responsive to identifying that the current acoustic fingerprint does not contain the ideal acoustic fingerprint, the computer provides notification that the current acoustic fingerprint does not contain the ideal acoustic fingerprint.

This application is a continuation-in-part of patent application U.S. Ser. No. 12/197,891, filed Aug. 25, 2008, entitled “Non-Intrusive Acoustic Monitoring for Equipment Diagnostic and Fault Reporting.”

### BACKGROUND OF THE INVENTION

1. Field

The disclosure relates generally to a computer implemented method, a computer program product, and a data processing system and more specifically the present application relates to a computer implemented method, a computer program product, and a data processing system for non-intrusive acoustic monitoring for equipment diagnostic and fault reporting.

2. Description of the Related Art

Commercially available pre-packaged machinery generally comes with some kind of fault detection and reporting. The electrical circuitry in this pre-packaged machinery may contain break switches and fuses for exception conditions. Probes can be placed as special interface ports to report current voltage and heat dissipation status. Similarly, the pre-packaged machinery may have electrical and mechanical circuitry consisting of fuses and interfaces for process for error detection and reporting.

However, most first chance error detection is typically empirical. A user may notice an anomaly in the system, such as a noise or malfunction. The user may then have the machinery repaired, all without the triggering of any mechanical or electrical fault detection scheme.

The empirically detected issue may or may not be an anomaly. However, whether or not the empirically detected issue is problematic cannot be determined until the user or a specialist examines the issue more closely. This close examination of the machinery may or may not require specialized probes or equipment and adequate knowledge of the machinery.

By way of example, a user may notice an abnormal humming noise when operating the user's automobile. The user may empirically conclude that the brakes of the automobile are not working properly.

In this scenario, the user has made a guess that the brakes are not working. In actuality, a different problem may be present with the automobile. A specialist may have to inspect the automobile further to confirm the guessed diagnosis by the user.

### SUMMARY

According to an illustrative embodiment, a method is provided for acoustic monitoring and fault reporting. A computer identifies a sound from a consumer device. Responsive to identifying the sound from a consumer device, the computer converts the sound to an acoustic signal. Responsive to converting the sound to an acoustic signal, the computer generates a current acoustic fingerprint from the acoustic signal. Responsive to generating the acoustic fingerprint, the computer identifies whether the current acoustic fingerprint contains an ideal acoustic fingerprint. Responsive to identifying that the current acoustic fingerprint does not contain the ideal acoustic fingerprint, the computer provides notification that the current acoustic fingerprint does not contain the ideal acoustic fingerprint.

According to an illustrative embodiment, a computer program product is provided for acoustic monitoring and fault reporting. The computer program product comprises one or more computer-readable, tangible storage devices. Program instructions, stored on at least one of the one or more storage devices, identify a sound from a consumer device. Program instructions, stored on at least one of the one or more storage devices, responsive to identifying the sound from a consumer device, convert the sound to an acoustic signal. Program instructions, stored on at least one of the one or more storage devices, responsive to converting the sound to an acoustic signal, generate a current acoustic fingerprint from the acoustic signal. Program instructions, stored on at least one of the one or more storage devices, responsive to generating the acoustic fingerprint, identify whether the current acoustic fingerprint contains an ideal acoustic fingerprint. Program instructions, stored on at least one of the one or more storage devices, responsive to identifying that the current acoustic fingerprint does not contain the ideal acoustic fingerprint, provide notification that the current acoustic fingerprint does not contain the ideal acoustic fingerprint.

According to an illustrative embodiment, a computer system is provided for acoustic monitoring and fault reporting. The computer system comprises one or more processors, one or more computer-readable memories and one or more computer-readable, tangible storage devices. Program instructions, stored on at least one of the one or more storage devices for execution by at least one of the one or more processors via at least one of the one or more memories, identify a sound from a consumer device. Program instructions, stored on at least one of the one or more storage devices for execution by at least one of the one or more processors via at least one of the one or more memories, responsive to identifying the sound from a consumer device, convert the sound to an acoustic signal. Program instructions, stored on at least one of the one or more storage devices for execution by at least one of the one or more processors via at least one of the one or more memories, responsive to converting the sound to an acoustic signal, generate a current acoustic fingerprint from the acoustic signal. Program instructions, stored on at least one of the one or more storage devices for execution by at least one of the one or more processors via at least one of the one or more memories, responsive to generating the acoustic fingerprint, identify whether the current acoustic fingerprint contains an ideal acoustic fingerprint. Program instructions, stored on at least one of the one or more storage devices for execution by at least one of the one or more processors via at least one of the one or more memories, responsive to identifying that the current acoustic fingerprint does not contain the ideal acoustic fingerprint, provide notification that the current acoustic fingerprint does not contain the ideal acoustic fingerprint.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a data flow between the various software and hardware components according to an illustrative embodiment;

FIG. 4 is a flowchart of a process for acoustic monitoring of a device and fault reporting according to an illustrative process;

FIG. 5 is a flowchart of a process for the acoustic monitoring of a device according to an illustrative embodiment; and

FIG. 6 is a flowchart of a process for monitoring acoustic fingerprints and generating notifications according to an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

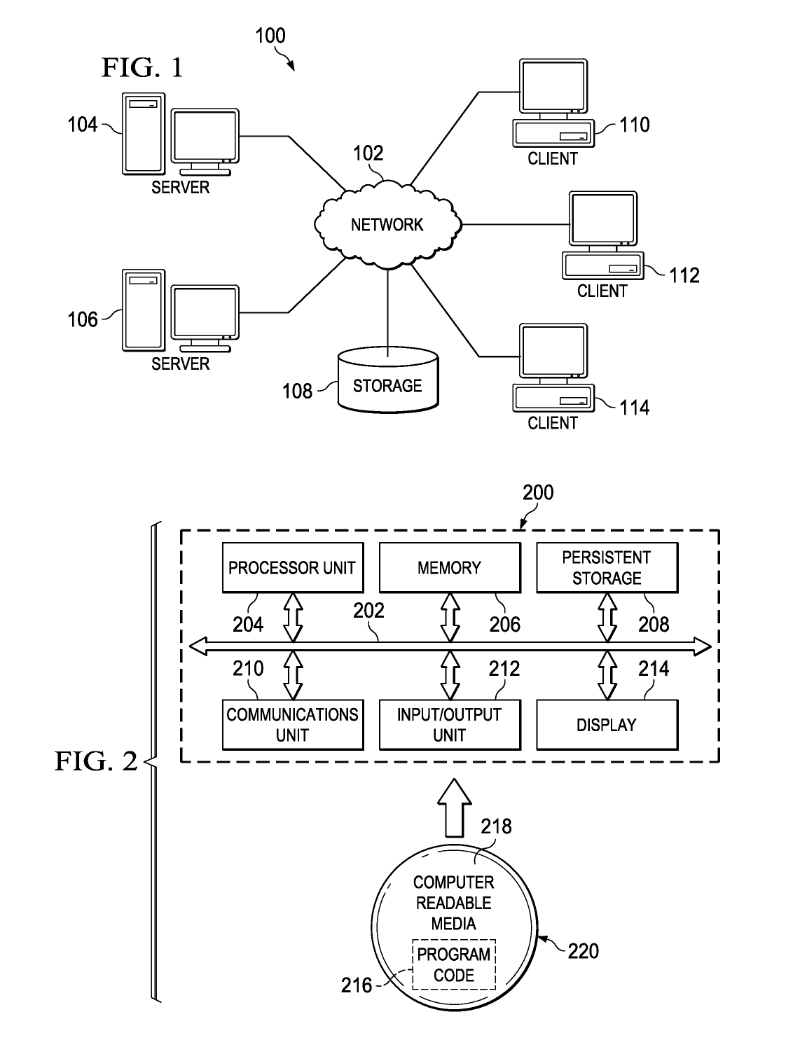

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments described herein provide a non-intrusive acoustic monitoring for equipment diagnostic and fault reporting. The non-intrusive controller may be placed in a piece of machinery to monitor and report on the machine's status. This device can be used to recognize acoustic levels for status monitoring and reporting. The controller monitors acoustic levels of a device and compares them to a sound fingerprint emitted by the device under normal conditions. The monitor can be configured to accept acoustic levels from one or multiple monitored devices

A method, computer program product, and a computer system are provided for acoustic monitoring and fault reporting. A computer identifies a sound from a consumer device. Responsive to identifying the sound from a consumer device, the computer converts the sound to an acoustic signal. Responsive to converting the sound to an acoustic signal, the computer generates a current acoustic fingerprint from the acoustic signal. Responsive to generating the acoustic fingerprint, the computer identifies whether the current acoustic fingerprint contains an ideal acoustic fingerprint. Responsive to identifying that the current acoustic fingerprint does not contain the ideal acoustic fingerprint, the computer provides notification that the current acoustic fingerprint does not contain the ideal acoustic fingerprint.

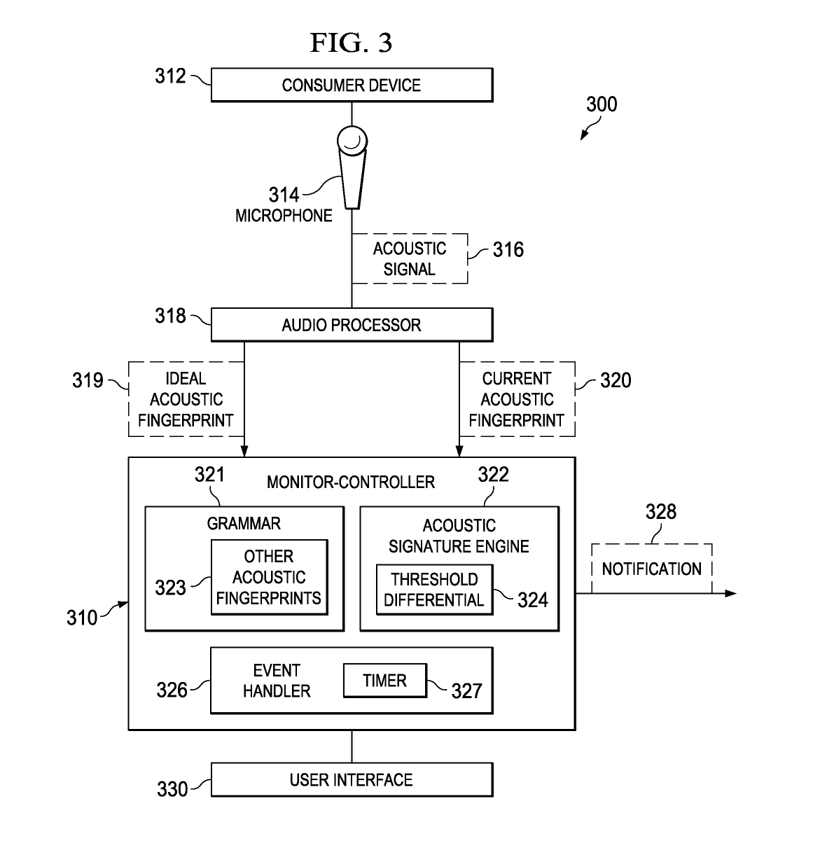

Referring now to FIG. 3, a data flow between the various software and hardware components is shown according to an illustrative embodiment. System 300 includes monitor-controller 310, which is a data processing system, such as data processing system 100 of FIG. 1.

Consumer device 312 can be any device that generates repetitious noise, hereinafter, an acoustic signal. Consumer device 312 can be, without limitation, a consumer household appliance, such as a washing machine, a clothes dryer, a dishwasher, a hot water heater, an air conditioning unit, a heat pump, or any other household device that generates an acoustic signal under normal operation. Consumer device 312 can also be, without limitation, a component or subsystem of a larger device, such as a transmission or brake rotor of an automobile.

Coupled to, or placed in close proximity of consumer device 312 is microphone 314. Microphone 314 detects sounds from consumer device 312. Acoustic signal 316 is the electrical signal produced by microphone 314 in response to detecting sound from consumer device 312.

During initialization of monitor-controller 310, monitor-controller 310 utilizes acoustic signal 316 to create ideal acoustic fingerprint 319. Audio processor 318 converts acoustic signal 316 into ideal acoustic fingerprint 319. Audio processor 318 can be a hardware-based component or software-based component. Acoustic signal 316 may undergo a Fourier transformation, or other digital transformation, to create ideal acoustic fingerprint 319. Ideal acoustic fingerprint 319 can be a spectral representation of acoustic signal 316 that is gathered during initialization of monitor-controller 310. Ideal acoustic fingerprint 319 is a spectral representation of acoustic signal 316 under normal operating condition of consumer device 312.

Characteristics of the transformed acoustic signal are isolated from the transformed acoustic signal and compared to known sample statistical models of known subject matter and performers to determine similarities using known methods, such as vector quantization, hidden Markov modeling, and multivariate auto-regression modeling. Alternatively, audio processor 318 can convert acoustic signal 316 using a hash method to obtain ideal acoustic fingerprint 319 as a compact representation of acoustic signal 316 under normal operating conditions of consumer device 312.

Ideal acoustic fingerprint 319 is then incorporated into grammar 321. Grammar 321 is a file that contains a list of acoustic fingerprints, such as ideal acoustic fingerprint 319 and other acoustic fingerprints 323 that acoustic signature engine 322 will recognize.

It should be recognized that grammar 321 can contain additional acoustic fingerprints, each of those acoustic fingerprints corresponding to a different known operating condition. For example, one acoustic fingerprint within grammar 321 may correspond to normal operating conditions, such as ideal acoustic fingerprint 319, wherein consumer device 312 is operating normally. Other acoustic fingerprints within grammar 321, such as other acoustic fingerprints 323, may correspond to other known operating conditions wherein consumer device 312 is operating with a known defect.

During operation of monitor-controller 310, monitor-controller 310 utilizes acoustic signal 316 to create current acoustic fingerprint 320. Audio processor 318 converts acoustic signal 316 into current acoustic fingerprint 320. Audio processor 318 can be a hardware-based component or software-based component. Acoustic signal 316 may undergo a Fourier transformation, or other digital transformation, to create current acoustic fingerprint 320. Current acoustic fingerprint 320 can be a spectral representation of acoustic signal 316 that is gathered during operation of monitor-controller 310. Current acoustic fingerprint 320 is a real-time or near-real-time spectral representation of acoustic signal 316 under current operating conditions of consumer device 312.

Characteristics of the transformed acoustic signal are isolated from the transformed acoustic signal, and compared to known sample statistical models of known subject matter and performers to determine similarities using known methods, such as vector quantization, hidden Markov modeling, and multivariate auto-regression modeling. Alternatively, audio processor 318 can convert acoustic signal 316 using a hash method to obtain current acoustic fingerprint 320 as a compact representation of acoustic signal 316 under current operating conditions of consumer device 312.

Current acoustic fingerprint 320 is then forwarded to monitor-controller 310. Monitor-controller 310 includes acoustic signature engine 322. Acoustic signature engine 322 is a software component that compares current acoustic fingerprint 320 to the acoustic fingerprints within grammar 321, including ideal acoustic fingerprint 319, taking into account threshold differential 324. Threshold differential 324 is an acceptable amount of statistical variance that current acoustic fingerprint 320 can differ from ideal acoustic fingerprint 319 during operation of consumer device 312. The acceptable statistical variance is a deviation by which current acoustic fingerprint 320 may differ from threshold differential 324 without triggering event handler 326. Monitor-controller 310 works on principles similar to those found in voice recognition systems that monitor for the occurrence of a particular waveform. Ideal acoustic fingerprint 319 is incorporated into a grammar by which consumer device 312 can communicate with monitor-controller 310. During operation of consumer device 312, monitor-controller 310 attempts to match current acoustic fingerprint 320 to stored acoustic fingerprints within grammar 321. That is, monitor-controller 310 identifies whether ideal acoustic fingerprint 319 or other acoustic fingerprints 323 within grammar 321 is contained within current acoustic fingerprint 320. Current acoustic fingerprint 320 contains ideal acoustic fingerprint 319 or other acoustic fingerprints 323 if ideal acoustic fingerprint 319 or other acoustic fingerprints 323 can be identified within current acoustic fingerprint 320, based on principles similar to those found in voice recognition systems that monitor for the occurrence of a particular waveform. If monitor-controller 310 identifies that ideal acoustic fingerprint 319 is contained within current acoustic fingerprint 320, as bounded by threshold differential 324, then consumer device 312 is determined to be operating under the known condition corresponding to ideal acoustic fingerprint 319. If monitor-controller 310 identifies that current acoustic fingerprint 320, as bounded by threshold differential 324, then consumer device 312 is determined to be operating under the known condition corresponding to ideal acoustic fingerprint 319.

Event handler 326 is a software component that notifies a user if current acoustic fingerprint 320, as bounded by threshold differential 324, is not identified within ideal acoustic fingerprint 319. If acoustic signature engine 322 determines that ideal acoustic fingerprint 319, as bounded by threshold differential 324, is not identified within current acoustic fingerprint 320, acoustic signature engine 322 triggers event handler 326. Event hander 326 provides notification 328 to a user or other person that ideal acoustic fingerprint 319, as bounded by threshold differential 324, is not identified within current acoustic fingerprint 320.

In one illustrative embodiment, event handler 326 includes timer 327. If acoustic signature engine 322 determines that ideal acoustic fingerprint 319, as bounded by threshold differential 324, is not identified within current acoustic fingerprint 320, acoustic signature engine 322 starts timer 327. Timer 327 is a measure of a particular time duration. Timer 327 can be, for example, but not limited to, a clock counter and a countdown timer. Acoustic signature engine 322 continues to monitor current acoustic fingerprint 320 during the duration of timer 327. If acoustic signature engine 322 identifies ideal acoustic fingerprint 319 within current acoustic fingerprint 320 prior to an expiration of timer 327, event handler 326 does not trigger notification 328. However, if acoustic signature engine 322 does not identify ideal acoustic fingerprint 319 within current acoustic fingerprint 320 prior to an expiration of timer 327, event handler 326 triggers notification 328.

Notification 328 can be provided in a number of different ways. For example, notification 328 can be provided by an auditory or visual alarm, such as a siren or a light emitting diode indicator. Notification 328 also can be an email or short messaging service formatted (text message) alert sent to a user at a mobile or desktop data processing system, such as one of clients 110-114 of FIG. 1.

In one preferred embodiment, a user is provided with user interface 330 to access monitor-controller 310. Through user interface 330, a user can adjust the defined statistical variance for threshold differential 324. Through user interface 330, a user may also be able to reset ideal acoustic fingerprint 319 to correspond to current acoustic fingerprint 320. User interface 330 may also provide an output for notification 328, such that a user can determine whether ideal acoustic fingerprint 319, as bounded by threshold differential 324, is not identified within current acoustic fingerprint 320 by examining user interface 330.

In one illustrative embodiment, if current acoustic fingerprint 320 is not identified within grammar 321, a user can flag current acoustic fingerprint 320 as an unknown fingerprint. During a subsequent diagnostic of consumer device 312, an operating condition of consumer device 312 can be determined. The operating condition may or may not already be associated with a known acoustic fingerprint within grammar 321. If the operating condition is not associated with a known acoustic fingerprint, the acoustic fingerprint can be incorporated into grammar 321 and associated with the operating condition determined during the diagnostic. If the operating condition is associated with a known acoustic fingerprint, the new acoustic fingerprint can be incorporated into grammar 321 and associated with the known operating condition, such that the known operating condition can have more than one acoustic fingerprint associated therewith.

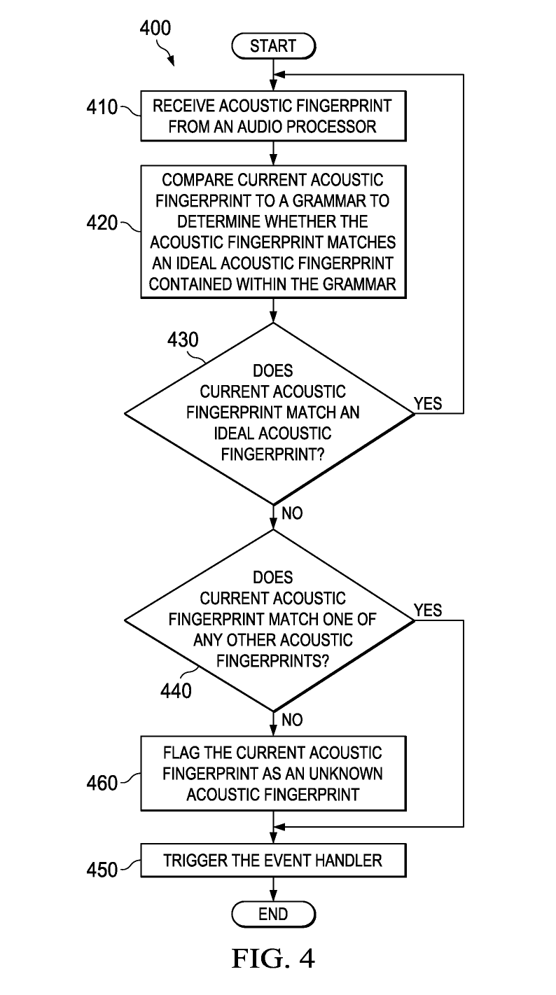

Referring now to FIG. 4, a flowchart of a process for acoustic monitoring of a device and fault reporting is shown according to an illustrative process. Process 400 is a software process executing on a software component, such as acoustic signature engine 322 of FIG. 3.

Process 400 begins by receiving an acoustic fingerprint from an audio processor (step 410). The acoustic fingerprint can be current acoustic fingerprint 320 of FIG. 3.

Responsive to receiving the acoustic fingerprint, process 400 compares the current acoustic fingerprint to a grammar to determine whether the acoustic fingerprint matches an ideal acoustic fingerprint contained within the grammar (step 420). The grammar can be grammar 321 of FIG. 3. The ideal acoustic fingerprint can be for example, ideal acoustic fingerprint 319 of FIG. 3. By comparing the acoustic fingerprint to the known acoustic fingerprints, process 400 identifies whether the current acoustic fingerprint contains a known acoustic fingerprint, such as ideal acoustic fingerprint 319 FIG. 3.

Process 400 then determines whether the current acoustic fingerprint matches an ideal acoustic fingerprint contained within the grammar (step 430). Responsive to determining that the current acoustic fingerprint matches an ideal acoustic fingerprint contained within the grammar (“yes” at step 430)), process 400 returns to step 410 in an iterative fashion. Because the current acoustic fingerprint matches contain the ideal acoustic fingerprint, the current operating condition of the consumer device is known. In this case, the operating condition is normal.

Responsive to determining that the current acoustic fingerprint does not match an ideal acoustic fingerprint contained within the grammar (“no” at step 430)) process 400 compares the current acoustic fingerprint to a grammar to determine whether the current acoustic fingerprint matches one of any other acoustic fingerprints contained within the grammar (step 440). The grammar can be grammar 321 of FIG. 3. The other acoustic fingerprint can be for example, other acoustic fingerprints 323 of FIG. 3. By comparing the acoustic fingerprint to the known acoustic fingerprints, process 400 identifies whether the current acoustic fingerprint contains any of the other known acoustic fingerprints, such as one of other acoustic fingerprints 323 FIG. 3.

Responsive to determining that the current acoustic fingerprint matches an other acoustic fingerprint contained within the grammar (“yes” at step 440)), process 400 triggers the event handler (step 450) with the process terminating thereafter. The event handler can then provide a notification to a user or other person that the current acoustic fingerprint contains an other acoustic fingerprint. The notification may be notification 328 of FIG. 3. The notification may also include an indication of the known operating condition corresponding to the identified other acoustic fingerprint.

Returning now to step 440, responsive to determining that the current acoustic fingerprint does not match an other acoustic fingerprint contained within the grammar, (“no” at step 440), process 400 flags the current acoustic fingerprint as an unknown acoustic fingerprint (step 460). Process 400 then triggers the event handler (step 450) with the process terminating thereafter. The event handler can then provide a notification to a user or other person that the current acoustic fingerprint contains an unknown acoustic fingerprint. The notification may be notification 328 of FIG. 3. During a subsequent diagnostic of the consumer device, a current operating condition of the consumer device can be determined. The unknown acoustic fingerprint can be incorporated into grammar 321, and associated with the operating condition determined during the diagnostic.

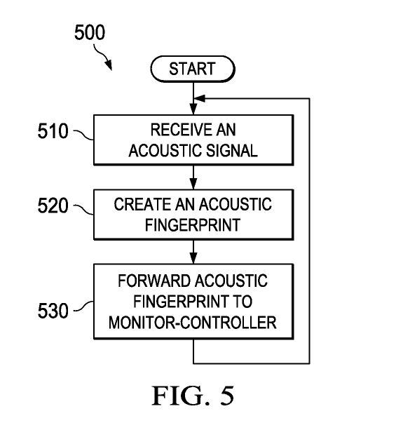

Referring now to FIG. 5, a flowchart of a process for the acoustic monitoring of a device is shown according to an illustrative embodiment. Process 500 can be a software process, executing on a software component, such as audio processor 318 of FIG. 3.

Process 500 begins by receiving an acoustic signal (step 510). The acoustic signal, which can be acoustic signal 316 of FIG. 3, is the electrical signal produced by a microphone in response to detecting sound from a monitored device, such as consumer device 312 of FIG. 3.

Responsive to receiving the acoustic signal, process 500 creates an acoustic fingerprint (step 520). The acoustic signal may undergo a Fourier transformation, or other digital transformation, to create the acoustic fingerprint. The acoustic fingerprint can be a spectral representation of the acoustic signal. Characteristics of the transformed acoustic signal are isolated from the transformed media signal, and compared to known sample statistical models of known subject matter and performers to determine similarities using known methods, such as vector quantization, hidden Markov modeling, and multivariate auto-regression modeling. Alternatively, the acoustic signal can be converted using a hash method to obtain the acoustic fingerprint as a compact representation of the acoustic signal.

Responsive to converting the acoustic signal into an acoustic fingerprint, process 500 forwards the acoustic fingerprint to a monitor-controller (step 530). Process 500 then returns to step 510 in an iterative manner to poll for, and receive subsequent acoustic signals.

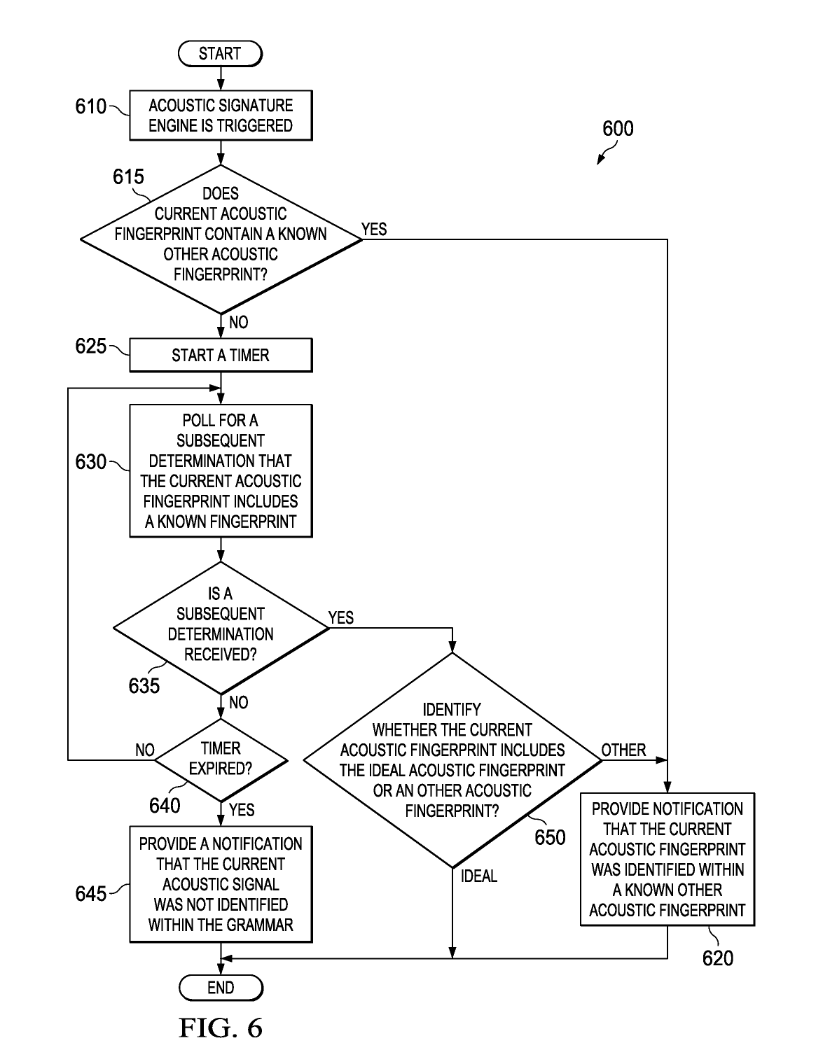

Referring now to FIG. 6, a flowchart of a process for monitoring acoustic fingerprints and generating notifications is shown according to an illustrative embodiment. Process 600 is a software process executing on a software component, such as event handler 326 of FIG. 3. Process 600 begins when triggered by an acoustic signature engine (step 610). The acoustic signature engine can be acoustic signature engine 322 of FIG. 3.

Process 600 then determines whether a current acoustic fingerprint containing a known other acoustic fingerprint is contained within the grammar (step 615). The known other acoustic fingerprints can be other acoustic fingerprints 323 of FIG. 3. Responsive to the current acoustic fingerprint containing a known other acoustic fingerprint (“yes” at step 615), process 600 provides a notification that the current acoustic fingerprint was identified within a known other acoustic fingerprint (step 620). The notification may also include the known operating condition corresponding to the other acoustic fingerprint. Process 600 terminates thereafter.

Returning now to step 615, responsive to the current acoustic fingerprint not containing a known other acoustic fingerprint (“no” at step 615), process 600 starts a timer (step 625). The timer is a timer, such as timer 327 of FIG. 3.

Process 600 then begins to poll the acoustic signature engine for a subsequent determination that the current acoustic fingerprint includes a known fingerprint (step 630). The known fingerprint can be, for example, one of ideal acoustic fingerprint 319 or other acoustic fingerprints 323 of FIG. 3. Process 600 then determines whether a subsequent determination that the current acoustic fingerprint includes a known fingerprint is received (step 635). If a subsequent determination that the current acoustic fingerprint includes a known fingerprint is not received, (“no” at step 635), process 600 continues to step 640 to determine whether the timer has expired.

If the timer has not yet expired (“no” at step 640), then process 600 iterates back to step 630 and continues to poll for the subsequent determination. However, if the timer has expired (“yes” at step 640), process 600 provides a notification that the current acoustic signal was not identified within the grammar (step 645). Process 600 terminates thereafter.

Returning now to step 635, if a subsequent determination that the current acoustic fingerprint includes a known fingerprint is received, (“yes” at step 635), then process 600 identifies whether the current acoustic fingerprint includes the ideal acoustic fingerprint or an other acoustic fingerprint (step 650). If the current acoustic fingerprint includes the ideal acoustic fingerprint (“ideal” at step 650), process 600 terminates. Because the ideal acoustic fingerprint was identified within the current acoustic fingerprint, the consumer device is determined to be operating normally. Therefore, there is no need to provide notification of any abnormality.

Returning now to step 650, if the current acoustic fingerprint includes an other acoustic fingerprint (“other” at step 650), process 600 iterates back to step 620. Process 600 provides a notification that the current acoustic fingerprint was identified within a known other acoustic fingerprint. The notification may also include the known operating condition corresponding to the other acoustic fingerprint. Process 600 terminates thereafter.

Thus, the illustrative embodiments described herein provide a non-intrusive acoustic monitoring for equipment diagnostic and fault reporting. The non-intrusive controller may be placed in a piece of machinery to monitor and report on the machine's status. This device can be used to recognize acoustic levels for status monitoring and reporting. The controller monitors acoustic levels of a device and compares them to a sound fingerprint emitted by the device under normal conditions. The monitor can be configured to accept acoustic levels from one or multiple monitored devices.

A method, computer program product, and a computer system are provided for acoustic monitoring and fault reporting. A computer identifies a sound from a consumer device. Responsive to identifying the sound from a consumer device, the computer converts the sound to an acoustic signal. Responsive to converting the sound to an acoustic signal, the computer generates a current acoustic fingerprint from the acoustic signal. Responsive to generating the acoustic fingerprint, the computer identifies whether the current acoustic fingerprint contains an ideal acoustic fingerprint. Responsive to identifying that the current acoustic fingerprint does not contain the ideal acoustic fingerprint, the computer provides notification that the current acoustic fingerprint does not contain the ideal acoustic fingerprint.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for acoustic monitoring and fault reporting, the method comprising:
a computer identifying a sound from a consumer device;
responsive to identifying the sound from a consumer device, the computer converting the sound to an acoustic signal;
responsive to converting the sound to an acoustic signal, the computer generating a current acoustic fingerprint from the acoustic signal;
responsive to generating the acoustic fingerprint, the computer identifying whether the current acoustic fingerprint contains an ideal acoustic fingerprint; and
responsive to identifying that the current acoustic fingerprint does not contain the ideal acoustic fingerprint, the computer providing notification that the current acoustic fingerprint does not contain the ideal acoustic fingerprint.

2. The method of claim 1, wherein the step of identifying whether the current acoustic fingerprint contains an ideal acoustic fingerprint further comprises:
the computer identifying if a waveform of the ideal acoustic fingerprint occurs within a waveform of the current acoustic fingerprint.

3. The method of claim 1, further comprising:
responsive to identifying that the current acoustic fingerprint does contain the ideal acoustic fingerprint, the computer determining that an operating condition of the consumer device is normal.

4. The method of claim 1, further comprising:
the computer identifying whether the current acoustic fingerprint contains an other acoustic fingerprint; and
responsive to identifying whether the current acoustic fingerprint contains the other acoustic fingerprint, the computer providing notification the current acoustic fingerprint contains the other acoustic fingerprint.

5. The method of claim 4, wherein the step of identifying whether the current acoustic fingerprint contains the other acoustic fingerprint further comprises:
the computer identifying if a waveform of the other acoustic fingerprint occurs within a waveform of the current acoustic fingerprint.

6. The method of claim 4, further comprising:
responsive to identifying that the current acoustic fingerprint contains the other acoustic fingerprint, the computer identifying an operating condition of the consumer device, wherein the operating condition corresponds to a known defect; and
wherein the step of providing notification the current acoustic fingerprint contains the other acoustic fingerprint further comprises the computer providing notification of the known defect.

7. The method of claim 1, further comprising:
responsive to identifying that the current acoustic fingerprint does not contain the ideal acoustic fingerprint, the computer triggering an event handler, wherein the event handler provides notification that the current acoustic fingerprint does not contain the ideal acoustic fingerprint.

8. The method of claim 7, wherein the event handler provides notification by triggering an auditory alarm, triggering a visual alarm, sending an email, or sending a short messaging service formatted alert.

9. A computer program product for acoustic monitoring and fault reporting, the computer program product comprising:
one or more computer-readable, tangible storage devices;
program instructions, stored on at least one of the one or more storage devices, to identify a sound from a consumer device;
program instructions, stored on at least one of the one or more storage devices, responsive to identifying the sound from a consumer device, to convert the sound to an acoustic signal;
program instructions, stored on at least one of the one or more storage devices, responsive to converting the sound to an acoustic signal, to generate a current acoustic fingerprint from the acoustic signal;
program instructions, stored on at least one of the one or more storage devices, responsive to generating the acoustic fingerprint, to identify whether the current acoustic fingerprint contains an ideal acoustic fingerprint; and
program instructions, stored on at least one of the one or more storage devices, responsive to identifying that the current acoustic fingerprint does not contain the ideal acoustic fingerprint, to provide notification that the current acoustic fingerprint does not contain the ideal acoustic fingerprint.

10. The computer program product of claim 9, wherein the program instructions to identify whether the current acoustic fingerprint contains an ideal acoustic fingerprint further comprises:
program instructions, stored on at least one of the one or more storage devices, to identify if a waveform of the ideal acoustic fingerprint occurs within a waveform of the current acoustic fingerprint.

11. The computer program product of claim 9 further comprising:
program instructions, stored on at least one of the one or more storage devices, responsive to identifying that the current acoustic fingerprint does contain the ideal acoustic fingerprint, to determine that an operating condition of the consumer device is normal.

12. The computer program product of claim 9 further comprising:
program instructions, stored on at least one of the one or more storage devices, to identify whether the current acoustic fingerprint contains an other acoustic fingerprint; and
program instructions, stored on at least one of the one or more storage devices, responsive to identifying whether the current acoustic fingerprint contains the other acoustic fingerprint, to provide notification that the current acoustic fingerprint contains the other acoustic fingerprint.

13. The computer program product of claim 12, wherein program instructions to identify whether the current acoustic fingerprint contains the other acoustic fingerprint further comprises:
program instructions, stored on at least one of the one or more storage devices, to identify if a waveform of the other acoustic fingerprint occurs within a waveform of the current acoustic fingerprint.

14. The computer program product of claim 12 further comprising:
program instructions, stored on at least one of the one or more storage devices, responsive to identifying that the current acoustic fingerprint contains the other acoustic fingerprint, to identify an operating condition of the consumer device, wherein the operating condition corresponds to a known defect; and
wherein the program instructions to provide notification that the current acoustic fingerprint contains the other acoustic fingerprint further comprises the computer providing notification of the known defect.

15. The computer program product of claim 14, further comprising:
program instructions, stored on at least one of the one or more storage devices, responsive to identifying that the current acoustic fingerprint does not contain the ideal acoustic fingerprint, to trigger an event handler, wherein the event handler provides notification that the current acoustic fingerprint does not contain the ideal acoustic fingerprint.

16. The computer program product of claim 15, wherein the event handler provides notification by triggering an auditory alarm, triggering a visual alarm, sending an email, or sending a short messaging service formatted alert.

17. A computer system for acoustic monitoring and fault reporting, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to identify a sound from a consumer device;
program instructions, stored on at least one of the one or more storage devices for execution by at least one of the one or more processors via at least one of the one or more memories, responsive to identifying the sound from a consumer device, to convert the sound to an acoustic signal;
program instructions, stored on at least one of the one or more storage devices for execution by at least one of the one or more processors via at least one of the one or more memories, responsive to converting the sound to an acoustic signal, to generate a current acoustic fingerprint from the acoustic signal;
program instructions, stored on at least one of the one or more storage devices for execution by at least one of the one or more processors via at least one of the one or more memories, responsive to generating the acoustic fingerprint, to identify whether the current acoustic fingerprint contains an ideal acoustic fingerprint; and
program instructions, stored on at least one of the one or more storage devices for execution by at least one of the one or more processors via at least one of the one or more memories, responsive to identifying that the current acoustic fingerprint does not contain the ideal acoustic fingerprint, to provide notification that the current acoustic fingerprint does not contain the ideal acoustic fingerprint.

18. The computer system of claim 17, wherein the program instructions to identify whether the current acoustic fingerprint contains an ideal acoustic fingerprint further comprises:
program instructions, stored on at least one of the one or more storage devices for execution by at least one of the one or more processors via at least one of the one or more memories, to identify if a waveform of the ideal acoustic fingerprint occurs within a waveform of the current acoustic fingerprint.

19. The computer system of claim 17 further comprising:
program instructions, stored on at least one of the one or more storage devices for execution by at least one of the one or more processors via at least one of the one or more memories, responsive to identifying that the current acoustic fingerprint does contain the ideal acoustic fingerprint, to determine that an operating condition of the consumer device is normal.

20. The computer system of claim 17 further comprising:
program instructions, stored on at least one of the one or more storage devices for execution by at least one of the one or more processors via at least one of the one or more memories, to identify whether the current acoustic fingerprint contains an other acoustic fingerprint; and
program instructions, stored on at least one of the one or more storage devices for execution by at least one of the one or more processors via at least one of the one or more memories, responsive to identifying whether the current acoustic fingerprint contains the other acoustic fingerprint, to provide notification that the current acoustic fingerprint contains the other acoustic fingerprint.
